(19) United States
(12) Patent Application Publication
(10) Pub. No.: US 2011/0132739 A1
(43) Pub. Date: Jun. 9, 2011

(54) DEVICES AND METHOD FOR REMOVING IMPURITIES FROM WATER USING LOW GRADE HEAT

(75) Inventor: John T. Dieckmann, Belmont, MA (US)

(73) Assignee: TIAX LLC, %Nadine Andon, Lexington, MA (US)

(21) Appl. No.: 12/737,490

(22) PCT Filed: Jul. 15, 2009
(86) PCT No.: PCT/US2009/050737

§ 371 Date: Jan. 18, 2011

Related U.S. Application Data
(60) Provisional application No. 61/135,789, filed on Jul. 16, 2008.

(51) Int. Cl. C02F 1/04; B01D 5/00; B01D 1/14

(52) U.S. Cl. 203/10; 202/185.2

(57) ABSTRACT

A method and system for removing impurities from water including heating a first gas stream including a first gas or a gas mixture and pre-humidifying the first gas stream using water from an impure water source. Heat may be transferred the first gas stream to a second gas stream, wherein the second gas stream includes a second gas or a gas mixture and wherein the first gas stream and the second gas stream flow in opposing directions. Water may be condensed out of the first gas stream and the second gas stream may be contacted with impure water, evaporating at least a portion of water from the impure water into the second gas stream to humidify the second gas stream. The first gas stream and the second gas stream are sustained at or near ambient pressure.

### FIELD OF THE INVENTION

The present disclosure relates to devices and methods for removing impurities from water, e.g., for the purpose of producing distilled water or for concentrating impurities. Any low grade heat source, including waste process heat can be used to supply thermal energy to the devices and methods.

### BACKGROUND

Waste water may be understood as any water that contain impurities. Such waste or impure water may be from industrial, municipal or household sources including, human waste, septic tank discharge, sewage treatment plant discharge, highway drainage, storm drains, or industrial site drainage, including industrial cooling waters, industrial process waters, etc. When waste water enters the natural environment, water pollution may occur, which may adversely affect the natural environment, including any plants or species living in such environment. Emphasis has recently been placed on controlling water pollution and the reclamation of waste water due to government regulation and increased profitability from resource management.

### SUMMARY OF THE INVENTION

An aspect of the present disclosure relates to a method of removing impurities from water. The method may include heating a first gas stream including a first gas or a gas mixture and pre-humidifying the first gas stream using water from an impure water source. The method may also include transferring heat from the first gas stream to a second gas stream, wherein the second gas stream may include a second gas or a gas mixture and wherein the first gas stream and the second gas stream may flow in opposing directions. In addition, water may be condensed out of the first gas stream and the second gas stream may be contacted with impure water and at least a portion of water may be evaporated from the impure water into the second gas stream to humidify the second gas stream. The first gas stream and the second gas stream may be sustained at or near ambient pressure.

Another aspect of the present disclosure relates to a system for removing impurities from water. The system may include at least one counter-flow heat exchanger wherein the counter-flow heat exchanger may include at least one pair of flow channels including a condensing channel and an evaporator channel. The system may also include a pre-humidifier in fluid communication with the at least one condensing channel and a flue in thermal communication with the pre-humidifier. The system may further include an impure water inlet providing fluid communication between an impure water source and the at least one evaporator channel, as well as at least one water outlet in fluid communication with the at least one condensing channel.

A further aspect of the present disclosure relates to a condensing cell having a proximal end and a distal end. The cell may include a condensing channel, including at least one wall, wherein the condensing channel includes an inlet at the proximal end and an outlet at the distal end. The cell may also include an evaporator channel, wherein at least a portion of the evaporator channel is defined by the at least one wall, and the evaporator channel includes an inlet at the distal end and an outlet at the proximal end. In some examples, the cell may also include a manifold providing fluid communication between the condensing channel inlet and a humidified and heated air source as well as an impure water distribution manifold for providing communication between an impure water source and the evaporator channel.

### BRIEF DESCRIPTION OF THE DRAWINGS

The above-mentioned and other features of this disclosure, and the manner of attaining them, may become more apparent and better understood by reference to the following description of embodiments described herein taken in conjunction with the accompanying drawings, wherein:

FIG. 1 illustrates a schematic of an example of a pre-humidifier;

FIG. 2 illustrates a schematic of an example of a vapor distillation system;

FIG. 3 illustrates a schematic of an example of a counter-flow heat exchanger;

FIG. 4 illustrates a schematic of an example of temperature profiles across a nominal channel length;

FIG. 5 illustrates a schematic of an example of humidity profiles across a nominal channel length;

FIG. 6 illustrates a schematic of an example of a counter-flow heat exchanger including a number of condenser/evaporator cells;

FIG. 7a illustrates a schematic of an example of a cross-section condenser/evaporator cell and FIG. 7b illustrates a schematic of an example of an end view of a proximal end of a condenser/evaporator cell;

FIG. 8 illustrates a schematic of an example of cross-section of an example of a condenser/evaporator cell; and

FIG. 9 illustrates a schematic of an example of an application of a system.

### DETAILED DESCRIPTION

The present disclosure relates to devices and methods for removing impurities from impure or waste water, e.g., for the purpose of producing distilled water or for concentrating impurities. As previously noted, impure water may be understood as any water that may contain impurities. Such waste or impure water may be by from industrial, municipal or household sources including, human waste, septic tank discharge, sewage treatment plant discharge, highway drainage, storm drains, or industrial site drainage, including industrial cooling waters or industrial process waters, etc. Distilled water may be understood as water in which a substantial portion of impurities may be removed by evaporation and subsequent condensation.

Impure water may include inorganic as well as organic matter. For example, impure water from industrial site drainage may include biocide, heat, slimes, or silt, as well as sand, alkalis, oil, chemical residues, etc. The total dissolved solids may provide an indicator of the combined content of inorganic as well as organic substances in the impure water in molecular, ionic or colloidal form. In some examples, the impure water may include a total dissolved solids content in the range of 100 ppm or greater, such as from 100 ppm to 300,000 ppm. While suspended solids may be present in the impure water, the suspended solids may be removed by filtration or otherwise be precipitated from the impure water during processing.

The process water may be purified using waste heat, including low grade waste heat. The waste heat may be derived from, for example, industrial processes, which may be generally understood herein to encompass, not only flue gasses or exhaust gasses from smelters, fireplaces, ovens, furnaces, boiler, or steam generators, as well as other forms of exhaust gas emitted as a result of the combustion of fuels, such as natural gas, gasoline, diesel, fuel oil or coal but also heat generated from chemical engineering processes such as oil and gas processes, incinerators such as garbage incinerators, and/or power generation processes. Low grade waste heat may be understood as waste heat exhibiting a temperature in the range of 25° C. to 300° C., including all values and increments therein, such as 75° C. to 150° C., 200° C. to 250° C., etc. The waste heat may be directly or indirectly supplied to the purification process as will be discussed further below.

The waste heat may be used to aid in vapor distillation of the impure water. Vapor distillation may be understood as a process to produce distilled water, wherein the system may be sustained or maintained at or near ambient or atmospheric pressure. At or near ambient pressure may be understood to be in the range of +/−10 kPa, including all values and increments therein, such as +/−1 kPa, +/−4 kPa, etc. It may be appreciated that in some embodiments, no compressors or pumps are necessary.

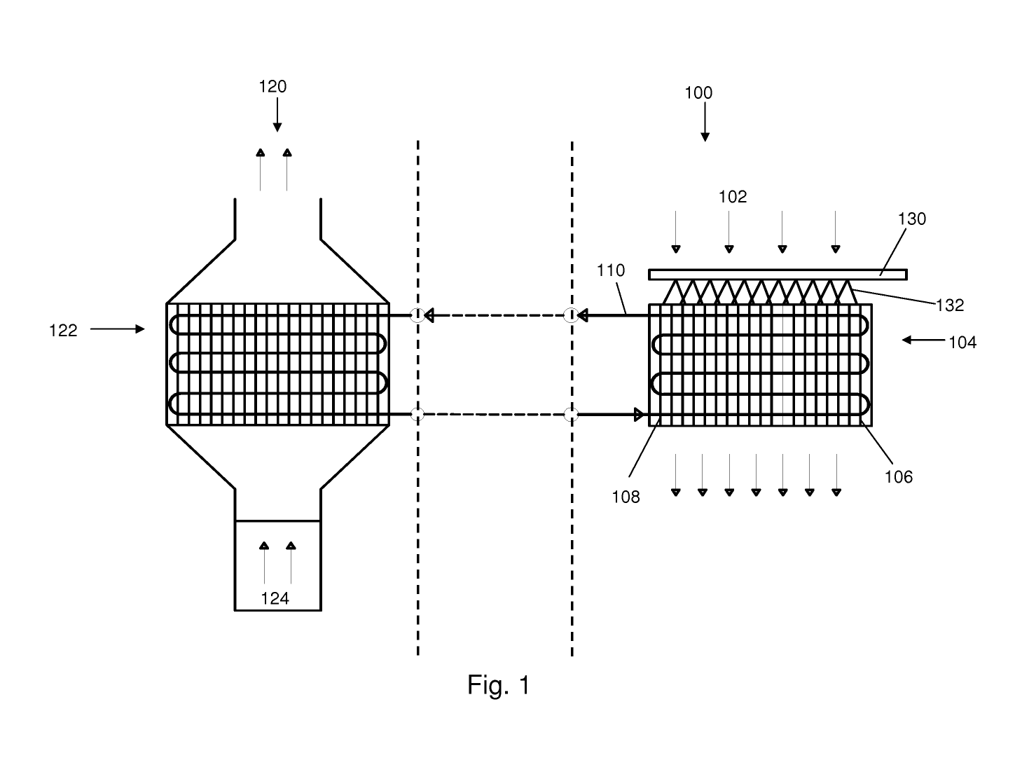

In some examples, prior to the beginning of the vapor distillation process a first gas stream gas or a gas mixture, such as air, may be humidified and/or heated. The first gas stream may be sourced from outdoor air, a gas supply tank, or process air that may be scrubbed or otherwise treated to remove most contaminants. The first gas stream may be heated and humidified by a pre-humidification process. An example of such a process is illustrated in FIG. 1, wherein a pre-humidifier 100 is in thermal communication with a waste heat stream, such as a flue 120. A first gas stream 102 may pass through or around a first heat exchanger 104 present in the pre-humidifier. The heat exchanger may include a plurality of fins 106 or other heat transfer elements, such as coils, which may contact at least a portion of the first gas stream.

The first heat exchanger 104 may include a circuit 108 for carrying a heat transfer medium 110. The circuit 108 may be in fluid communication with a second heat exchanger 122 present in the flue 120. The circuit 108 may pass through the heat exchanger or may be in fluid communication with a second circuit located in the second heat exchanger 122. The heat transfer medium may include, for example, air or liquids such as water, polyalkylene glycol, silicone oil, mineral oil, fluorocarbon oil, etc. The second heat exchanger may be positioned in the waste heat stream 124 such that waste heat may flow around or contact at least a portion of the second heat exchanger 122. The waste heat may be at an elevated temperature, such as a temperature in the range of 25° C. to 300° C., including all values or increments therein. As noted above, waste heat may be understood to include waste heat generated from industrial processes including the combustion of fuels or exhaust gasses from fireplaces, ovens, furnaces, boilers or steam generators, nuclear reactors, etc.

The heat exchange medium temperature may be raised upon exposure to the waste heat in the second heat exchanger, which may be provided in the path of a waste heat stream. Circulating the heat exchange medium back to the first heat exchanger may result in the increase in temperature of the first heat exchanger. At least a portion of the first gas stream may contact the first heat exchanger causing an increase in the first gas stream temperature from a first ambient temperature which, in some examples, may be in the range of −30° C. to 50° C., including all values and increments therein, to a second heated temperature, which may be in the range of 40° C. to 150° C., including all values and increment therein. In addition, in some examples, the first gas stream may exhibit a dew point in the range of 40° C. to 100° C., including all values and increments therein.

Humidity may be imparted to the first gas stream by the use of a water inlet 130, such as a water distribution system or manifold. The manifold may include one or more sprayers 132, which may spray impure water into the first gas stream before, or as the gas stream enters the first heat exchanger 104. The impure water may also contact the heat transfer elements 106 of the first heat exchanger and evaporate off the surface of the heat transfer elements into the first gas stream. The impure water may be obtained from an impure water source, such as those described above, i.e., industrial site drainage, rainwater runoff, sewage treatment plant discharge, etc., and the water inlet may provide fluid communication between the impure water source and the water distribution system.

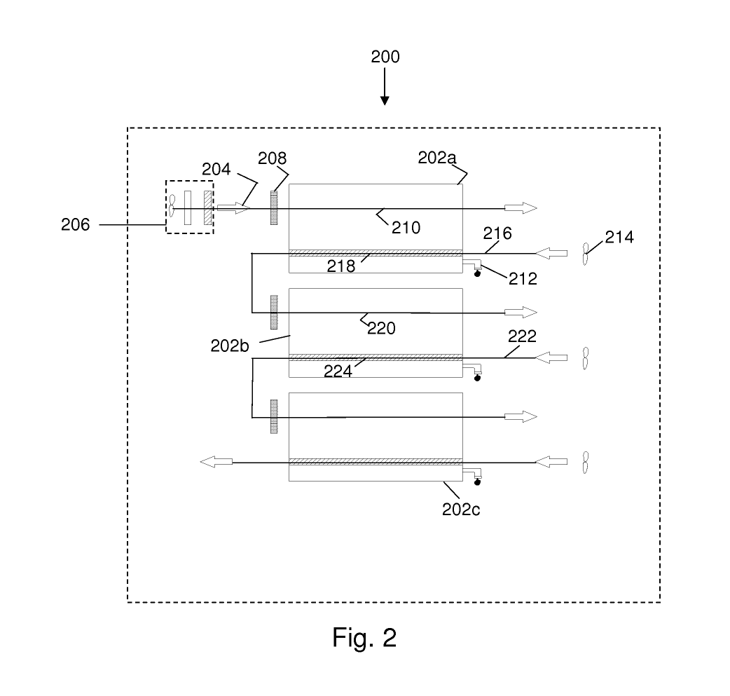

The heated and humidified first gas stream may then be directed into a vapor distillation system, as illustrated in FIG. 2. The vapor distillation system 200 may include one or more heat exchangers 202a, 202b, 202c. In some examples, the heat exchangers may be counter-flow heat exchangers, further described below. Prior to directing the first gas stream 204 into the vapor distillation system, and after pre-humidification 206, the first gas stream may be de-misted by a demister 208, removing suspended water droplets. In some examples, the demister may be a mesh type coalescer, vane pack or other structure that may aggregate mist into droplets that may be heavy enough to separate from the air stream. Upon passing through the heat exchanger, such as through a condensing channel 210, water may condense out of the first gas stream and pass through an outlet 212 in the heat exchanger. Water exiting the outlets may then be collected and re-treated by vapor distillation and/or another purification process.

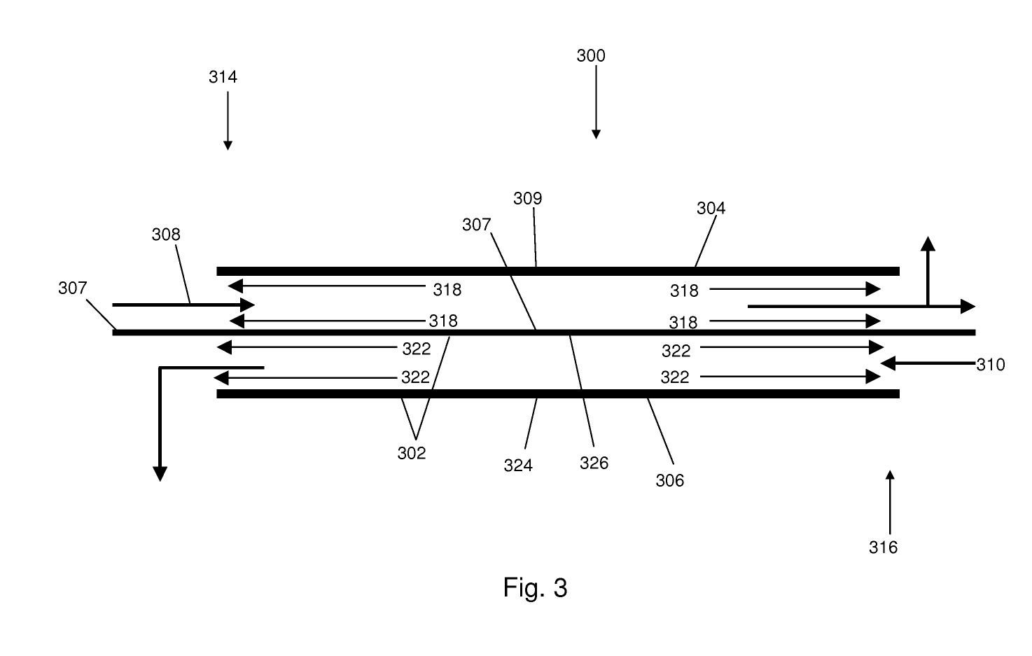

As noted above, the heat exchanger may be a counter-flow heat exchanger, an example of which is illustrated in the schematic diagram of FIG. 3. The counter-flow heat exchanger 300 may include at least one pair of channels 302 (as illustrated, however it may be appreciated that a number of channel pairs may be provided). The pair of channels may include a condensing channel 304 and an evaporator channel 306. The channels may share at least one common wall 307 or may individually have walls that are capable of transferring heat between the channels. Therefore, it may be appreciated that at least a portion of the pair of channels may be adjacent to each other.

The heated and humidified first gas stream 308 may be directed through the condensing channel and a second gas stream 310 may be directed through the evaporator channel in an opposing direction. The second gas stream may again include a gas or a gas mixture, such as air. It may be appreciated that the second gas stream may be sourced from outdoor air, a gas supply tank, or process air that may be scrubbed or otherwise treated to remove most contaminants. An air blower (with reference to FIG. 2, see 214) may be provided to direct the second gas stream through the evaporator channel.

The first gas stream may enter a proximal end 314 of the counter-flow heat exchanger at a first temperature T₁ and the second gas stream may enter a distal end 316 of the counter-flow heat exchanger at a second temperature T₂, which may be relatively lower than that of the first gas stream, wherein T₁>T₂. Heat may be transferred from the first gas stream to the second gas stream through the wall (or walls), reducing the temperature of the first gas stream to a third temperature T₃ upon exiting the heat exchanger and increasing the temperature of the second gas stream T₄ upon exiting the heat exchanger.

As the temperature of the first gas stream is reduced below the dew point, water 318 may condense out of the gas stream and may travel along the channel walls 307, 309. In addition, impure water may be distributed into the evaporator channel by a distribution manifold. The impure water 322 may contact and run down the walls of the evaporator channel 324 and 326 (which may, in some embodiments be the same wall as 307) and a portion of the water may be evaporated into the second gas stream as the temperature of the second gas stream rises. The temperature and humidity level of the second air stream exiting the counter-flow heat exchanger may be at or near the temperature and/or humidity level of the first air stream upon entering the counter-flow heat exchanger.

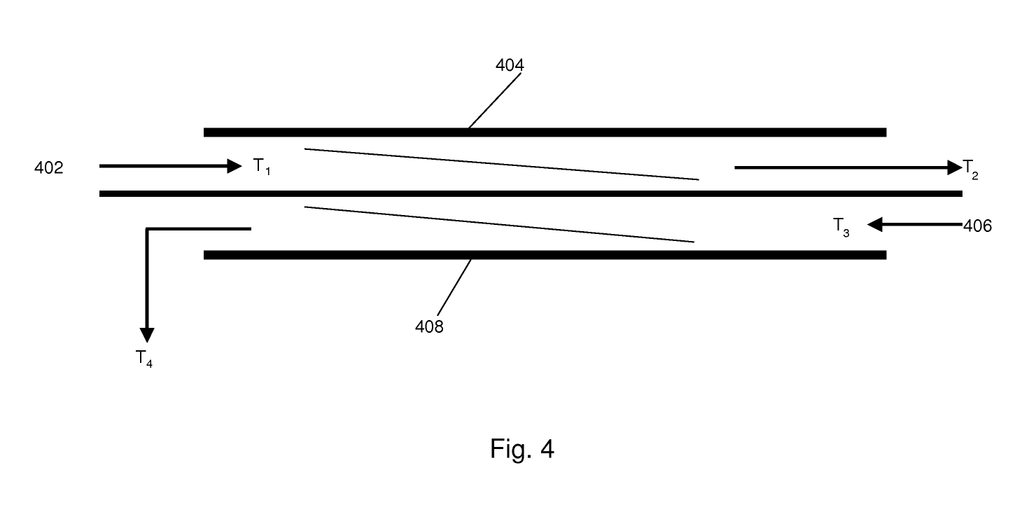

An example of a temperature profile for the channel pair is illustrated in FIG. 4 along a nominalized length of a channel pair, which in some examples may be in the range of 1 meter to 12 meters, including all values and increments therein, such as 1.5 meters, 3 meters, etc. As can be seen in the figure, the temperature T₁ of the first gas stream 402 entering the condensing channel 404 may be relatively high, compared to the temperature T₂ of the first gas stream 402 exiting the condensing channel 404. In addition, the temperature T₃ of the second gas stream 406 entering the evaporator channel 408 may be relatively low, compared to the temperature T₄ of the second gas stream 406 exiting the evaporator channel 408. Furthermore, the temperature of the first gas stream T₁ entering the condensing channel 404 may be greater than the temperature of the second gas stream T₃ entering the evaporator channel, wherein T₁>T₃. It may be appreciated, that in a general sense, T₁ is greater than T₂ (T₁>T₂) and that T₄ is greater than T₃ (T₄>T₃). It may also be appreciated that T₂ may be greater than or equal to T₃ (T₂≧T₃) and, in some cases T₂ may be less than or equal to T₄ (T₂≦T₄). Furthermore, it may be appreciated that T₄ may be less than T₁ (T₄<T₁) and, in some cases, T₄ may be greater than or equal to T₃ (T₄≧T₃).

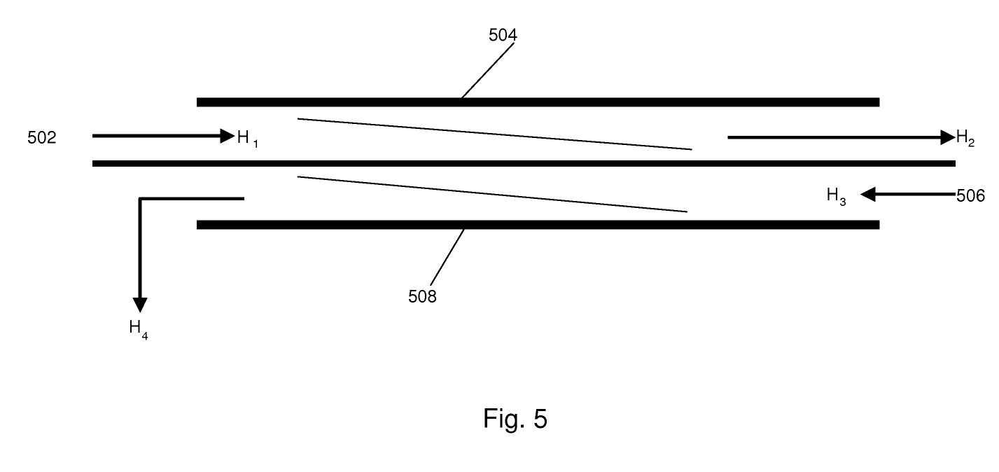

The dew point of the first and second gas streams may exhibit somewhat similar trends as the temperature exhibited in the channels along the nominalized length of a channel pair entering and exiting the heat exchangers as illustrated in FIG. 5. The dew point H₁ of the first gas stream 502 entering the condensing channel 504 is relatively high, compared to the dew point of the first gas stream H₂ exiting the condensing channel. In addition, the dew point H₃ of the second gas stream 506 entering the evaporator channel 508 may be relatively low, compared to the dew point H₄ of the second gas stream 506 exiting the evaporator channel 508. It may be appreciated, that in a general sense, H₁ is greater than H₂ (H₁>H₂) and that H₄ is greater than H₃ (H₄>H₃). It may also be appreciated that H₂ may be greater than or equal to H₃ (H₂≧H₃) and, in some cases H₂ may be less than or equal to H₄ (H₂≦H₄). Furthermore, it may be appreciated that H₄≦H₁ and, in some cases, H₄ may be greater than or equal to H₃ (H₄≧H₃).

In one set of embodiments, T₄ may be within 50 percent to 100 percent of T₁. In addition, the dew point H₄ of the second gas stream exiting the counter-flow heat exchanger may be within 50 to 100 percent of the dew point H₁ of the first gas stream entering the counter-flow heat exchanger, including all values and increments therein. Furthermore, the dew point H₂ of the first gas stream exiting the counter-flow heat exchanger may be within 50 to 100 percent of the dew point level H₃ of the second gas stream entering the counter-flow heat exchanger.

Referring again to FIG. 2, the second gas stream 216 may be directed into the heat exchanger through the evaporator channel 218 wherein heat may be transferred between the first and second gas streams causing condensation of water from the first gas stream and evaporation of water from the impure water into the second gas stream. The process of condensation and evaporation may be repeated in additional heat exchangers wherein the second or subsequent gas stream exiting the evaporator channel is directed into a condensing channel of the next heat exchanger. Therefore, as illustrated, the second gas stream, upon exiting the first heat exchanger 202a, may then be directed into a condensing channel 220 in a second or subsequent heat exchanger 202b. Additional fans or blowers may be used to facilitate movement of the gas streams in the evaporator channels. A third gas stream 222, which again may include a gas or a gas mixture, such as air, may be directed into the evaporator channel 224 of the second or subsequent heat exchanger 202b. The third gas stream may include a portion of the first gas stream that exited the first heat exchanger or may be independent of the first gas stream. In addition, it may be appreciated that the first gas stream may be recycled into the pre-humidifier as well.

As illustrated in FIG. 2, the process of condensation and evaporation occurs three times; however, it may be appreciated that the process may be repeated many more times, such as from 1 to 15 times, exhibiting a cascading effect, generating distilled water. Accordingly, the addition of fourth, fifth, sixth, etc., gas streams may be contemplated. It may be appreciated that the gas streams may include similar or different gas compositions and may, in some cases, be remixed with prior gas streams. In addition, the temperature and/or dew point profiles of FIGS. 4 and 5 may be similar for the second or subsequent counter-flow heat exchangers in the system. It may be appreciated that additional heat need not be added to subsequent gas streams entering the condensing channels of the heat exchangers and that the relative humidity may remain somewhat constant, at or near 100%. In addition, in some cases, the collected, distilled water may exhibit a total dissolved solids content of less than 100 ppm, or less than 10 ppm, or less than 0.1 ppm, etc.

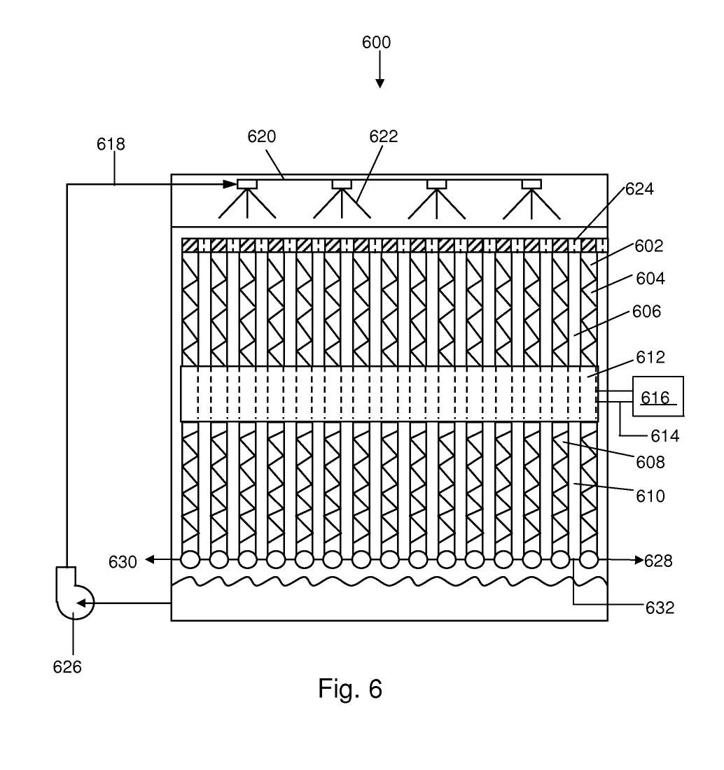

An example of an individual counter-flow heat exchanger is illustrated in FIG. 6. The counter-flow heat exchanger 600 may include one or more condenser/evaporator cells 602, wherein a condensing channel 604 may be defined in a cell and an evaporator channel 606 may be defined by the condensing channel and an adjacent cell 608. Accordingly, at least a portion of a wall 610 of the condensing (and adjacent) channel may form a portion of a wall of the evaporator channel. It may be appreciated that in some arrangements, the evaporator channel may be formed by a separate wall that may contact at least a portion of the walls of the condensing channel in a thermally conductive manner. In addition, it may be appreciated that the arrangement may be reversed, wherein the evaporator channel may be formed by a cell and the condensing channel may be defined by two or more cells.

The counter-flow heat exchanger may also include gas distribution manifolds 612 for the first, second and/or additional streams of gas. In the illustrated example, the gas distribution manifold 612 may provide communication between the pre-humidification system and at least one condensing channel. The gas distribution manifold may include an inlet 614 that provides fluid communication between the gas distribution manifold and the pre-humidification system or another gas or gas mixture source 616. Furthermore, in some examples, a blower may be provided (as illustrated in FIG. 2) to facilitate directing a gas stream into the counter-flow heat exchanger.

In addition, the counter-flow heat exchanger may include a water inlet 618 that may provide fluid communication between an impure water source and at least one evaporator channel 606. The water inlet may include a water distribution manifold 620, which may include one or more sprayers 622 for spraying impure water into the heat exchanger. Water distribution spacers or slots 624 may also be provided to further distribute the impure water through the heat exchange manifold in the evaporator channels. Furthermore, a recirculation pump 626 may be provided in fluid communication with one or more evaporator channels for impure water that does not evaporate into the second gas stream.

Outlets 628 and 630 may also be provided in the heat exchanger to collect water that may condense in the condensing channels. The outlets may connected to a manifold 632 which is in fluid communication with at least one or more condensing channels. As noted above, the collected water may be further treated again by vapor distillation or other treatment processes.

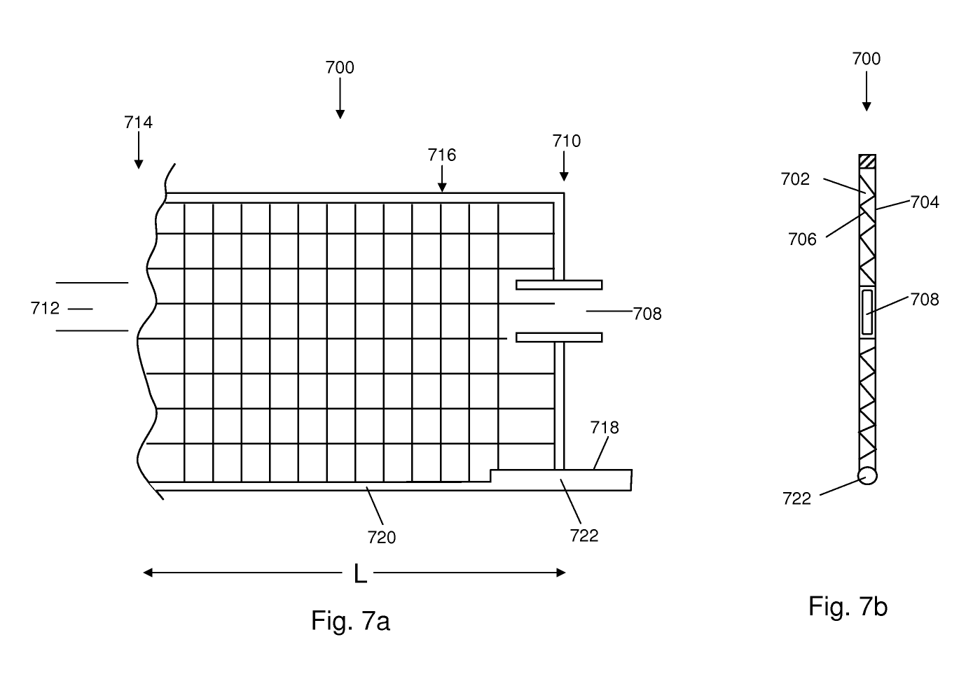

An example of an evaporator/condenser cell is illustrated in FIGS. 7a and 7b. In some examples, the cell 700 may include one or more sheets of polymer material forming the cell walls 702 and 704. Between the cell walls may be a spacer 706, which may be formed of crimped screen or mesh material. The cell walls may be spaced apart from 2 to 50 mm, including all values and increments therein, such as 5 mm to 10 mm, 10 mm to 15 mm, etc.

The cell may also include an inlet 708 at a proximal end 710 and an outlet 712 at a distal end 714. The inlet may allow for the introduction of a gas stream, such as a first gas stream into a condensing channel. A frame 716 may be provided to which the sheets may be attached or a sheet may be wrapped around and/or affixed. In the base of the frame 718, or as a separate element, a water collection trough 720 may be formed in which condensed water may be collected. The water collection trough may include a cell outlet 722, which may be in fluid communication with a collection manifold capable of communicating the collected water to an outlet in the heat exchanger. In addition, the water collection trough may be broken into a number of sections along the length of the counter-flow-heat exchanger restricting water flow along the length L. Referring back to FIG. 6, a number of cells may be stacked together, such that the walls or surface of the cells form evaporator channels. It may be appreciated that at least two cells or one cell and an additional cell wall (formed from a single sheet, which may be attached to the frame) may be used to form a single channel pair.

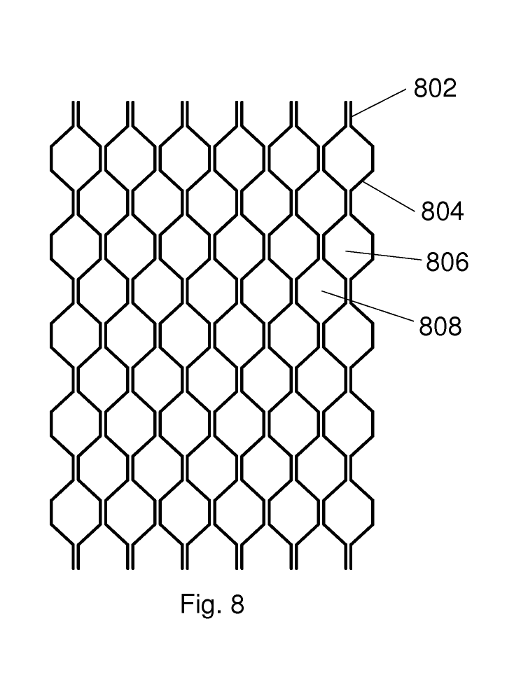

In another embodiment, the condensation/evaporation cells may be formed as illustrated in FIG. 8, wherein sheets 802 having a number of features 804 formed therein may be stacked forming channels 806, 808 with the features. For example, one row of channels 806 may be condensing channels and another row of channels 808 may be evaporator channels. It may be appreciated that at least three sheets may be used to form a single channel pair. While “half-hexagonal” features 804 are illustrated in the embodiment of FIG. 8, it may be appreciated that other features may be formed as well, including half-circles, half-ovals, squares, triangular features, herringbone patterns, etc. Furthermore, while it is illustrated that the features are illustrated as lining up to form a hexagonal shapes as between two sheets, it may be appreciated that spacing of the features may be varied or altered, by using different size features or different feature spacing. The features may be formed by thermoforming or other mechanical and/or thermal process for deforming the polymer material, such as extrusion. The features may be discreet or may extend along the length of a given sheet.

The sheets in the above examples may be formed from a polymer material. Such polymer material may include polyolefins (including polyethylene or polypropylene), polysulfone, nylon, vinyl, polyacetal or polyester (such as PET). In addition, where the sheets may be embossed polymer materials such as polyurethane, acrylonitrile butadiene styrene (ABS), acrylic, polycarbonate, polyethylene, polystyrene as well as other compositions may be contemplated. It may be appreciated that the polymer material may exhibit a Vicat Softening Point/Temperature, as measured by ASTM D1525 in the range of 60° C. or greater, including all values and increments in the range of 100° C. to 325° C. The sheets may have a thickness in the range of 0.005 mm to 1 mm, including all values and increments therein, such as 0.1 mm to 0.5 mm, or 0.25 mm to 0.3 mm, etc. The sheets may be bonded together or joined to a frame by one or more adhesives, snap fit/join assemblies, press fit assemblies, or other mechanical interlocks, mechanical fasteners such as screws or push-in fasteners, welding techniques including ultrasonic bonding, or solvent bonding.

One or more surfaces of the sheets may be treated. Such treatment may reduce microbial or other biological activity, including fungal, bacterial, viral, algal, etc. In further examples, the surfaces of the sheets may also be treated to reduce or facilitate the removal scale or other deposits that may accumulate on the sheets. In addition, treatment may alter the hydrophobicity of the sheets, which may be understood as the degree of affinity or repulsion a surface has to water.

Hydrophobicity may be indicated by the contact angle or the angle at which a liquid/vapor interface meets a solid surface and may be measured by the sessile drop method or measured by a goniometer among other techniques. For example, the contact angle of a surface of a sheet may be greater than 90 degrees, allowing water to spread out on a sheet, particularly, for example, in the evaporator channel where evaporation from the channel surface may occur. Hydrophobicity may be altered by methods such as corona treatment, plasma treatment, flame treatment, imprinting, coatings, chromic acid etching, sodium treatment, transcrystalline growth, UV exposure, etc. For example, treated sheets may be available from Film Specialties, Inc., under the tradename VISGARD and an example of a sheet coating may also be available from Film Specialities, Inc. under the same tradename. Sheet assemblies may be available from SPX cooling technologies under the tradename/product number MBX Crossflow Film Fill or MX Crossflow Film Fill.

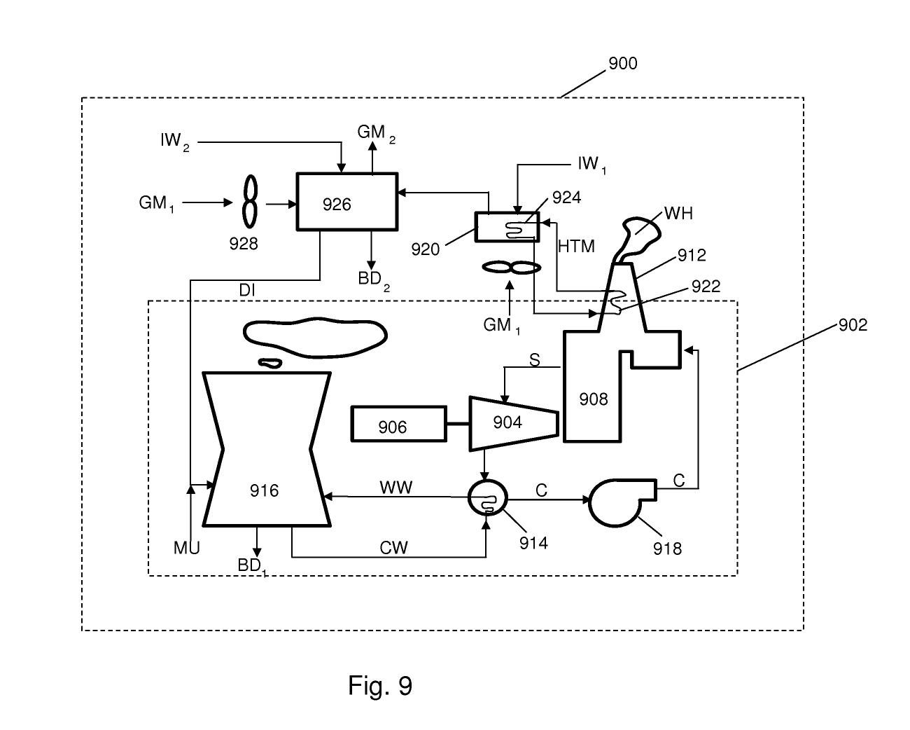

FIG. 9 illustrates a schematic diagram of an application of a system contemplated herein. In the system 900 and an embodiment of an application thereof, a power plant 902 may be used to generate steam S which acts on a turbine 904 operatively coupled to a generator 906 to produce electricity. The steam may be created in a boiler 908 heated by combustion or by a nuclear reactor. The boiler may produce waste heat WH, which may be exhausted by a flue 912. The steam may then be cooled 914 with cool water CW from a cooling tower 916 producing a condensate C and warm water WW. The condensate may be re-circulated by a pump 918 back into the boiler 908 and the warm water WW may be re-circulated back to the cooling tower 916. The cooling tower may produce blowdown BD₁, which may form an impure water source.

To remove impurities from impure water, a pre-humidifier 920 may be provided in thermal communication with the flue 912. As illustrated, a heat exchanger 922 may be provided in the waste heat WH which is in fluid communication with a second heat exchanger 924 in the pre-humidifier. A heat transfer medium HTM may be circulated between the first and second heat exchangers. Impure water IW₁ may be added to the pre-humidifier as described above from municipal (including household) or industrial water sources and a gas or a gas mixture GM₁, such as ambient air, may be added to the pre-humidifier.

The pre-humidifier may be in fluid communication with the vapor distillation system 926 described above, including one or more counter-flow heat exchangers. Impure water IW₂ may be added into the vapor distillation system, again from a number of sources described herein. Gas or a gas mixture GM₁ may also be added to the vapor distillation system from the ambient air around the vapor distillation system, which may be aided by a fan or blower 928. The vapor distillation process may produced distilled water DI, which may then be collected and utilized for applications such as cooling water in the cooling tower 916. The distilled water may be supplemented by a make up water source MU. The vapor distillation system may result in gas or a gas mixture GM₂ discharged into the environment as well as blowdown BD₂.

In some examples, the above system including the pre-humidifier and counter-flow heat exchangers may be employed in a number of other industrial applications as well to treat a variety of impure water sources. For example, the systems may be used in association with smelting facilities, kilns, foundries, power generation facilities including coal plants or nuclear plants, waste management facilities such as incinerators, or any other facility that may generate flue gasses or produce large amounts of waste heat. Such facilities may produce the impure water as industrial drainage, or impure water may be supplied to these facilities from municipal supplies including highway drainage, storm drains, or other drainage sources including, but not limited to, those mentioned above.

The foregoing description of several methods and embodiments has been presented for purposes of illustration. It is not intended to be exhaustive or to limit the claims to the precise steps and/or forms disclosed, and obviously many modifications and variations are possible in light of the above teaching. It is intended that the scope of the invention be defined by the claims appended hereto.

What is claimed is:

1. A method of removing impurities from water, comprising:
heating a first gas stream including a first gas or a gas mixture;
pre-humidifying said first gas stream using water from an impure water source;
transferring heat from said first gas stream to a second gas stream, wherein said second gas stream includes a second gas or a gas mixture and wherein said first gas stream and said second gas stream flow in opposing directions;
condensing water out of said first gas stream; and
contacting said second gas stream with impure water and evaporating at least a portion of water from said impure water into said second gas stream to humidify said second gas stream, wherein said first gas stream and said second gas stream are sustained at or near ambient pressure.

2. The method of claim 1, further comprising:
transferring heat from said second gas stream to at least one subsequent gas stream, wherein said second gas stream and said at least one subsequent gas stream flow in opposing directions and said at least one subsequent gas stream includes a at least one subsequent gas or a gas mixture;
condensing water out of said second gas stream;
contacting said at least one subsequent gas stream with impure water; and
evaporating at least a portion of water from said impure water into said at least one subsequent gas stream to humidify said third gas stream.

3. The method of claim 1, wherein said first gas stream is directed into a condensing channel of at least one counter-flow heat exchanger and said second gas stream is directed into an evaporating channel of said at least one counter-flow heat exchanger adjacent to said condensing channel.

4. The method of claim 3, further comprising directing said second gas stream or said at least one subsequent gas stream into an evaporating channel of at least one subsequent counter-flow heat exchanger.

5. The method of claim 3, wherein said second gas stream is directed into a condensing channel of a second counter-flow heat exchanger and a third gas stream is directed into an evaporating channel of said second counter-flow heat exchanger.

6. The method of claim 1, further comprising de-misting said first gas stream.

7. The method of claim 1, wherein said first gas stream is indirectly heated with waste heat.

8. The method of claim 1, wherein heating said first gas stream comprises:
transferring heat from waste heat to a heat transfer medium; and
transferring heat from said heat transfer medium to said first gas stream.

9. The method of claim 8, wherein said transferring heat comprises circulating said heat transfer medium through a first heat exchanger positioned in said waste heat and through a second heat exchanger positioned in said first gas stream.

10. The method of claim 1, wherein humidifying said first gas stream with water comprises spraying impure water into said first gas stream and evaporating at least a portion of water from said impure water into said first gas stream.

11. The method claim 1, wherein said impure water is sprayed into said second gas stream.

12. The method of claim 1, wherein said first gas stream is humidified with industrial site drainage.

13. The method of claim 1, wherein said first gas mixture and/or said second gas mixture comprises air.

14. The method of claim 2, wherein said third gas mixture comprises air.

15. The method of claim 1, wherein said first gas or gas mixture of said first gas stream is different than said second gas or gas mixture of said second gas stream.

16. The method of claim 2, wherein said third gas stream is independent from said first gas stream.

17. The method of claim 1, wherein said first gas stream exhibits a dew point in the range of 40° C. to 100° C.

18. The method of claim 1, wherein said first gas stream is heated to a temperature in the range of 40° C. to 150° C. at or near ambient pressure.

19. The method of claim 1, wherein said first gas stream is heated to a first temperature T₁ and said second gas stream has a third temperature T₃ prior to transferring heat from said first gas stream to said second gas stream, wherein T₁>T₃.

20. The method of claim 19, wherein said first gas stream is cooled to a second temperature T₂ after transferring heat from said first gas stream to said second gas stream, wherein T₂>T₃ and said second gas stream is heated to a fourth temperature T₄ after transferring heat from said first gas stream to said second gas stream, wherein T₄>T₃ and T₄<T₁.

21. The method of claim 2, wherein said second gas stream is heated to a first temperature T₁ and said at least one subsequent gas stream has a third temperature T₃ prior to transferring heat from said second gas stream to said at least one subsequent gas stream, wherein T₁>T₃.

22. The method of claim 21, wherein said second gas stream is cooled to a second temperature T₂ after transferring heat from said second gas stream to said at least one subsequent gas stream, wherein T₂>T₃ and said at least one subsequent gas stream is heated to a fourth temperature T₄ after transferring heat from said second gas stream to said at least one subsequent gas stream, wherein T₄>T₃ and T₄<T₁.

23. The method of claim 1, further comprising collecting said condensed water.

24. The method of claim 1, wherein said impure water has a total dissolved solids content of greater than 100 ppm.

25. A system for removing impurities from water, comprising:
at least one counter-flow heat exchanger wherein said counter-flow heat exchanger includes at least one pair of flow channels including a condensing channel and an evaporator channel;
a pre-humidifier in fluid communication with said at least one condensing channel;
a heat source in thermal communication with said pre-humidifier;
an impure water inlet providing fluid communication between an impure water source and said at least one evaporator channel; and
at least one water outlet in fluid communication with said at least one condensing channel.

26. The system of claim 25, wherein said heat source includes a first heat exchanger and said pre-humidifier comprises a second heat exchanger, wherein said thermal communication is provided between said first heat exchanger and second heat exchanger.

27. The system of claim 25, wherein said heat source is a waste heat source.

28. The system of claim 27, wherein said heat source is a flue gas stream.

29. The system of claim 25, wherein said pre-humidifier comprises an impure water sprayer.

30. The system of claim 25, further comprising at least one subsequent counter-flow heat exchanger wherein said evaporator channel of said at least one counter-flow heat exchanger is in fluid communication with said condensing channel of said subsequent counter-flow heat exchanger.

31. The system of claim 25, wherein said impure water inlet includes a distribution manifold.

32. The system of claim 25, further comprising an air blower in communication with at least one of said at least one evaporator channels.

33. The system of claim 25, comprising from 1 to 15 counter-flow heat exchangers.

34. The system of claim 25, further comprising two or more pairs of flow channels wherein said evaporator channel of a first pair of flow channels is in fluid communication with a condensing channel of another pair of flow channels.

35. A condensing cell for use in the system of claim 25, wherein said cell includes a proximal end and a distal end, the cell comprising:
a condensing channel, including at least one wall, wherein said condensing channel includes an inlet at said proximal end and an outlet at said distal end;
a manifold providing fluid communication between said condensing channel inlet and a humidified and heated air source;
an evaporator channel, wherein at least a portion of said evaporator channel is defined by said at least one wall, and said evaporator channel includes an inlet at said distal end and an outlet at said proximal end; and
an impure water distribution manifold for providing communication between an impure water source and said evaporator channel.

36. The condensing cell of claim 35, wherein said condensing channel and said evaporator channel are formed from sheets of polymer material.

37-38. (canceled)

39. The condensing cell of claim 36, wherein said polymer material is hydrophilic on a first surface, exhibiting a contact angle of less than 90 degrees.
